(19) United States
(12) Patent Application Publication
(10) Pub. No.: US 2017/0043464 A1
(43) Pub. Date: Feb. 16, 2017

(54) Nail Set

(71) Applicant: Gary A. Fielding, E. Alton, NH (US)

(72) Inventor: Gary A. Fielding, E. Alton, NH (US)

(21) Appl. No.: 15/235,293

(22) Filed: Aug. 12, 2016

Related U.S. Application Data
(60) Provisional application No. 62/204,141, filed on Aug. 12, 2015.

(51) Int. Cl. B25C 9/00

(52) U.S. Cl. CPC B25C 9/00

(57) ABSTRACT

An improved nail set and nail set kit that includes nail set having a body having a head adapted for striking with a hammer and a tip portion that includes a notch therein that is sized to accommodate the rectangular head of a pneumatically driven finish nail.

### CLAIM OF PRIORITY

This application claims the benefit of priority of U.S. Provisional Patent Application No. 62/204,141, filed on Aug. 12, 2015.

### FIELD OF THE INVENTION

The present invention relates generally to hand tools, and specifically to an improved nail set.

### BACKGROUND

Nail sets are generally used in woodworking for directing a nail which is protruding above the surface of the work-piece to a depth below the surface of the work-piece to eliminate exposure thereof and for allowing the resulting countersunk hole to be filled with appropriate material (e.g., wood putty) preparatory to finishing the work-piece.

As shown in FIGS. 1 and 2A, when the user nails finish nails 40 into the surface of the work-piece 22, the user often cannot drive the nail completely into the work-piece or the user will damage the surface of the work-piece. The nail set 10 is generally constructed and arranged such that a tip portion 14 of the nail set is placed on a head of the finish nail 40. In FIGS. 1 and 2A, the finish nail 40 is a straight finish nail. However, the term “finish nail” is intended to encompass finish nails, crown staples and other pneumatically driven fasteners used by carpenters in connection with finish work. The head of the nail set 10 is then struck with a hammer 50, which imparts force to the tip portion 14, driving the finish nail 40 completely into the work-piece 22.

Unfortunately, as shown in FIG. 2B, pneumatically driven finish nails 40 have a substantially rectangular head and the round tip portion 40 of the nail set 10 is prone to slipping off this rectangular head and driving downward into the work-piece. This causes the same or worse damage to the surface that the nail set 10 was intended to avoid.

Therefore, there is a need for an improved nail set that reduces the risk of the tip slipping off of the rectangular head of a pneumatically driven finish nail.

### SUMMARY OF THE INVENTION

The present invention is an improved nail set that includes a body having a head adapted for striking with a hammer and a tip portion that includes a notch therein that is sized to accommodate the rectangular head of a pneumatically driven finish nail.

In the preferred embodiment, the notch is a rectangular notch. In other embodiments, the notch may take the form of a trapezoid, an oval, a triangle, or other forms that will accommodate the nail head and resist slippage thereof during use.

In one embodiment of the kit, at least two nail sets, each having a different shaped notch, are provided.

In another embodiment of the kit, the nail set is combined with a finish nail having a head of a specific size and shape and the notch at the tip of the nail set is sized and shaped to accommodate the head of the nail.

Therefore, it is an aspect of the invention to provide an improved nail set that reduces the risk of the tip slipping off of the rectangular head of a pneumatically driven finish nail.

It is a further aspect of the invention to provide an improved nail set that may be easily manufactured from conventional nail sets.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a perspective view of a prior art nail set being used to drive a finish nail into a work-piece

FIG. 2A. is a front view of a prior art nail set with its tip aligned on the head of a finish nail.

FIG. 2B. is a front view of a prior art nail set with its tip embedded into a work-piece after slipping off the head of a finish nail.

FIG. 3A is an end view of the preferred embodiment of the nail set of the present invention having a rectangular notch.

FIG. 3B is a side view of the preferred embodiment of the nail set of FIG. 3A.

FIG. 4A is an end view of an alternative embodiment of the nail set of the present invention having a trapezoidal notch.

FIG. 4B is a side view of the embodiment of the nail set of FIG. 4A.

FIG. 5A is an end view of an alternative embodiment of the nail set of the present invention having an oval shaped notch.

FIG. 5B is a side view of the embodiment of the nail set of FIG. 5A.

FIG. 6A is an end view of alternative embodiment of the nail set of the present invention having a v-shaped notch.

FIG. 6B is a side view of the embodiment of the nail set of FIG. 6A.

FIG. 7A is a side view of the preferred embodiment of the nail set of the present invention in position to engage the rectangular head of a finish nail.

FIG. 7B is another side view of the embodiment of FIG. 7A rotated 90 degrees.

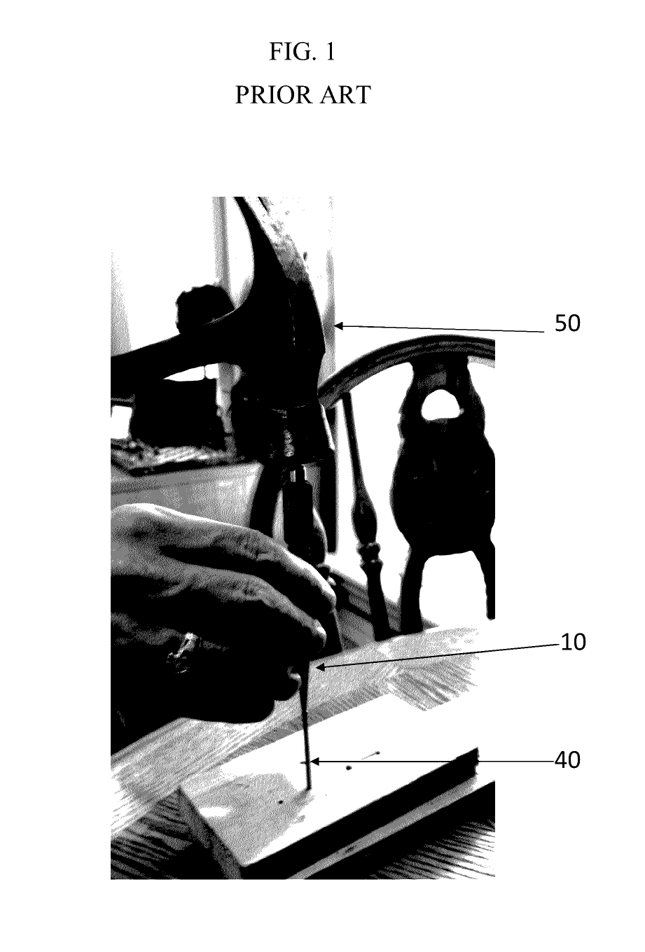

### DETAILED DESCRIPTION

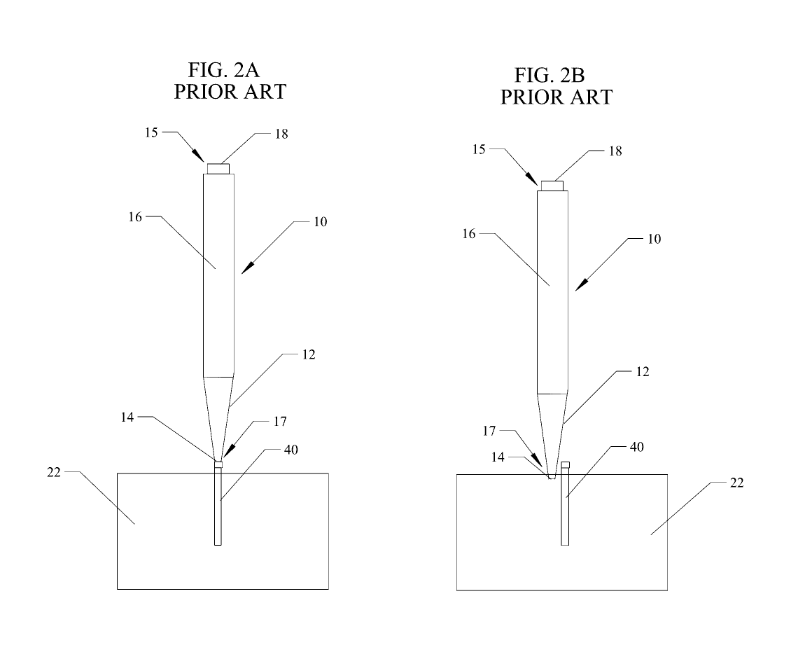

Looking first to prior art FIGS. 2A and 2B, the nail set of the present invention includes all of the features of a conventional nail set 10, including a head 18 dimensioned to be struck by a hammer 50, a body 16 including first end 15 near head 18 and second end 17 near a tapered portion 12, and a tip portion 14. The body 16, head 18, tapered portion 12, and tip portion 14 are preferably manufactured from a single piece of metal, such as tool steel. In some embodiments, the outside of the body 16 is covered with a plastic or rubberized material (not shown) to enhance grip on the nail set 10, but such a covering is not required.

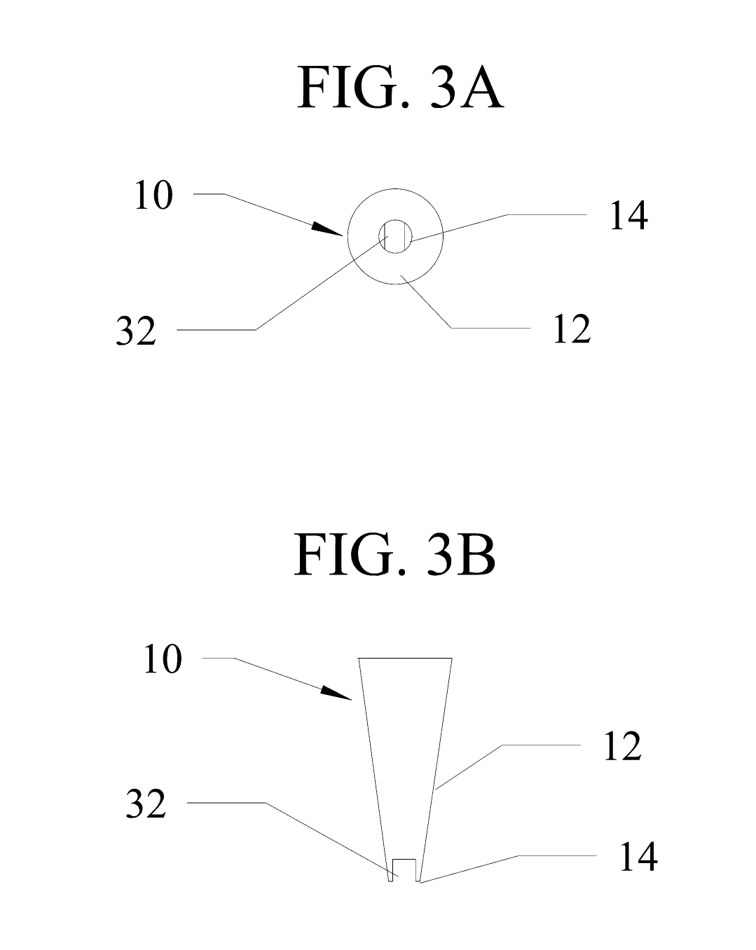

FIGS. 3A and 3B show the tapered portion 12 and tip portion 14 of the preferred nail set 10. In this embodiment, the tip portion 14 includes a substantially rectangular notch 32 that passes through the tip portion 14. As used herein, when it is said that notch 32 “passes through” tip portion 14, it is understood that notch 32 is a cutaway all the way through tip portion 14, as shown in FIG. 3B, for example. It is understood that notch 32 may also be entirely within tip portion 14. That is to say, it is possible for the tip portion 14 of a nail set 10 of the present invention to appear from its sides to be the same as a prior art nail set, but to include notch 32 within tip portion 14. The notch 32 is sized to accommodate the rectangular head of a pneumatic finish nail and to hold the tip portion 14 in place on the head while it is being driven.

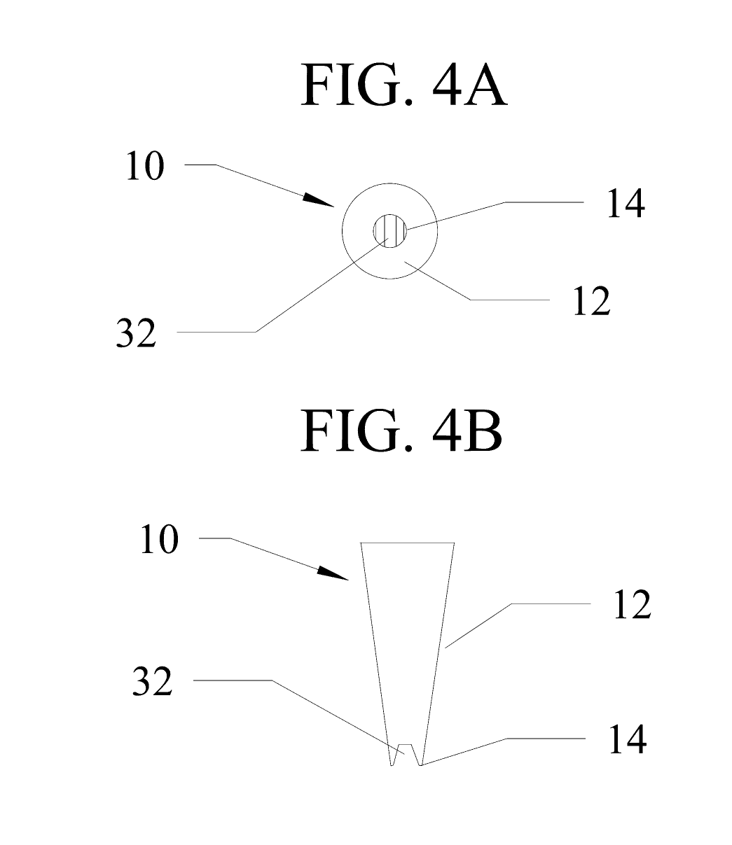

FIGS. 4A and 4B show the tapered portion 12 and tip portion 14 of an alternative nail set 10. In this embodiment, the tip portion 14 includes a substantially trapezoidal notch 32 that passes through the tip portion 14. The trapezoidal notch 32 is sized to accommodate the rectangular heads of a number of different sizes of pneumatic finish nails and to hold the tip portion 14 in place on the head while it is being driven.

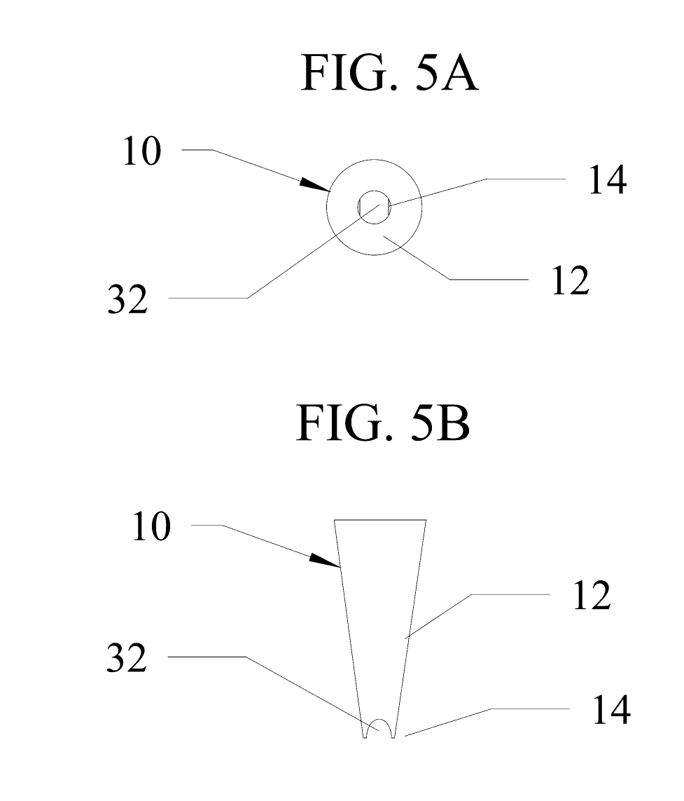

FIGS. 5A and 5B show the tapered portion 12 and tip portion 14 of another alternative nail set 10. In this embodiment, the tip portion 14 includes a substantially oval notch 32 that passes through the tip portion 14. The oval notch 32 is also sized to accommodate the rectangular heads of a number of different sizes of pneumatic finish nails and to hold the tip portion 14 in place on the head while it is being driven. However, as it is more prone to slippage, the oval notch is not preferred.

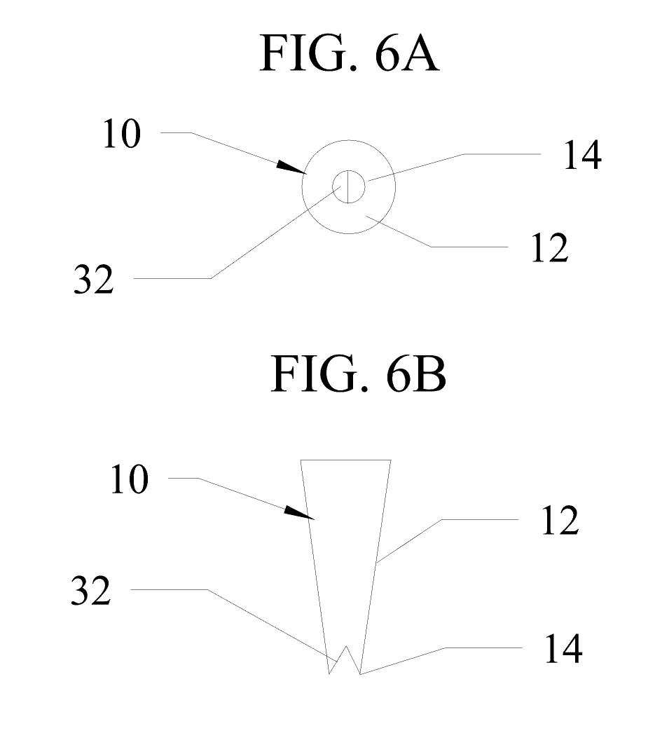

FIGS. 6A and 6B show the tapered portion 12 and tip portion 14 of another alternative nail set 10. In this embodiment, the tip portion 14 includes a substantially v-shaped notch 32 that passes through the tip portion 14. The v-shaped notch 32 is also sized to accommodate the rectangular heads of a number of different sizes of pneumatic finish nails and to hold the tip portion 14 in place on the head while it is being driven. However, as was the case with the oval notch of FIG. 5A, it is more prone to slippage and is not preferred.

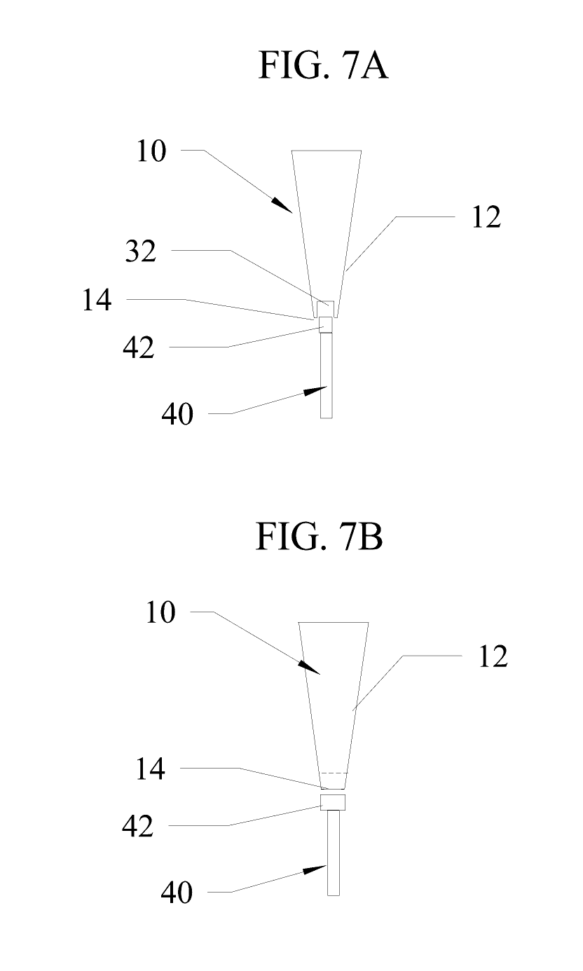

FIGS. 7A and 7B show the tapered portion 12 and tip portion 14 of the preferred nail set 10 in position to engage the rectangular head 42 of a pneumatic finish nail 40. The dashed line in FIG. 7B represents the top of notch 32 within the tip portion 14.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

I claim:

1. A nail set comprising:
a head dimensioned to be struck by a hammer;
a body comprising a first end and a second end, wherein said head is disposed at said first end of said body;
a tapered portion comprising a wide end that tapers into a narrow end, wherein said wide end is disposed at said second end of said body; and
a tip portion disposed at said narrow end of said tapered portion, wherein said tip portion comprises a notch that is sized to accommodate a head of a finish nail.

2. The nail set as claimed in claim 1, wherein said notch passes through said tip portion.

3. The nail set as claimed in claim 1, wherein said notch is rectangular.

4. The nail set as claimed in claim 1, wherein said notch is trapezoidal.

5. The nail set as claimed in claim 1, wherein said notch is oval shaped.

6. The nail set as claimed in claim 1, wherein said notch is v-shaped.

7. A nail set kit comprising:
a first nail set comprising:
a head dimensioned to be struck by a hammer;
a body comprising a first end and a second end, wherein said head is disposed at said first end of said body;
a tapered portion comprising a wide end that tapers into a narrow end, wherein said wide end is disposed at said second end of said body; and
a tip portion disposed at said narrow end of said tapered portion, wherein said tip portion comprises a notch having a first shape; and
a second nail set comprising:
a head dimensioned to be struck by a hammer;
a body comprising a first end and a second end, wherein said head is disposed at said first end of said body;
a tapered portion comprising a wide end that tapers into a narrow end, wherein said wide end is disposed at said second end of said body; and
a tip portion disposed at said narrow end of said tapered portion, wherein said tip portion comprises a notch having a second shape;

8. The nail set kit as claimed in claim 7, wherein said notch of said first nail set passes through said tip portion.

9. The nail set kit as claimed in claim 7, wherein said first shape of said notch of said first nail set is rectangular.

10. The nail set kit as claimed in claim 7, wherein said first shape of said notch of said first nail set is trapezoidal.

11. The nail set kit as claimed in claim 7, wherein said first shape of said notch of said first nail set is oval shaped.

12. The nail set kit as claimed in claim 7, wherein said first shape of said notch of said first nail set is v-shaped.

13. The nail set kit as claimed in claim 7 further comprising a third nail set comprising:
a head dimensioned to be struck by a hammer;
a body comprising a first end and a second end, wherein said head is disposed at said first end of said body;
a tapered portion comprising a wide end that tapers into a narrow end, wherein said wide end is disposed at said second end of said body; and
a tip portion disposed at said narrow end of said tapered portion, wherein said tip portion comprises a notch having a third shape.

14. A nail set kit comprising:
a nail set comprising:
a head dimensioned to be struck by a hammer;
a body comprising a first end and a second end, wherein said head is disposed at said first end of said body;
a tapered portion comprising a wide end that tapers into a narrow end, wherein said wide end is disposed at said second end of said body; and
a tip portion disposed at said narrow end of said tapered portion, wherein said tip portion comprises a notch; and
at least one finish nail comprising a head, wherein said notch of said nail set is sized and shaped to accommodate said head of said finish nail.

15. The nail set kit as claimed in claim 14, wherein said notch of said nail set passes through said tip portion.

16. The nail set kit as claimed in claim 14, wherein said notch of said nail set is rectangular.

17. The nail set kit as claimed in claim 14, wherein said notch of said nail set is trapezoidal.

18. The nail set kit as claimed in claim 14, wherein said notch of said nail set is oval shaped.

19. The nail set kit as claimed in claim 14, wherein said notch of said nail set is v-shaped.
